(19) United States
(12) Patent Application Publication
(10) Pub. No.: US 2026/0087478 A1
(43) Pub. Date: Mar. 26, 2026

(54) AUTONOMOUSLY ADAPTABLE PAYMENT TRANSACTIONS AND INTERFACES

(71) Applicant: BANO PTY LTD, New South Wales (AU)

(72) Inventor: Yue FENG, New South Wales (AU)

(21) Appl. No.: 19/108,847

(22) PCT Filed: Sep. 5, 2023
(86) PCT No.: PCT/AU2023/050859

§ 371 Date: Mar. 5, 2025

(30) Foreign Application Priority Data
Sep. 5, 2022 (AU) 2022902559

(51) Int. Cl. G06Q 20/22; G06Q 20/10; G06Q 20/14; G06Q 20/32; G06Q 20/34; G06Q 20/36; G06Q 20/38

(52) U.S. Cl. CPC G06Q 20/227; G06Q 20/102; G06Q 20/14; G06Q 20/326; G06Q 20/351; G06Q 20/36; G06Q 20/384; G06Q 20/386

(57) ABSTRACT

The disclosure is directed to automated systems and computer implemented methods to provide dynamic, adaptable and secure payment transaction interfaces are disclosed herein. In one aspect a method comprises receiving, by a client device, a data object that comprises a transaction request; executing, the data object, from an active application on the client device to trigger as a result of the executing, an adaptable transaction determination process, comprising determining, the active application that initiated the dynamic transaction interface; detecting, a default payment mechanism associated with the active application; and displaying, on the client device, the default payment mechanism on an adaptable transaction interface. The disclosed systems and methods allow for payments and other transactions to occur between a requesting party and recipient(s) of a transaction request via an adaptive smart interface that does not require applications to be installed or dedicated transaction accounts created on the recipient's device.

### TECHNICAL FIELD

The present technology pertains to systems and methods for providing a payment transaction interface that is adaptable to the program, and the operating systems it operates in. In particular, but not by way of limitation, the present technology provides systems and methods for autonomously adaptable payment transactions and interfaces.

### BACKGROUND

Splitting-bills or payments can be undertaken by current technologies by attempting to provide a uniform user interface to each user, usually via a shared application. However, current technologies fail to take into account or customize the experience based on each user's device, applications, and available payment methods, or the software environment the user is operating in.

### SUMMARY

In various aspects the present disclosure is directed generally to an automated computer implemented method to provide dynamic, adaptable and secure payment transaction interfaces based on a runtime environment, the method comprising receiving, by a client device, a data object that comprises a transaction request; executing, the data object, from an active application on the client device to trigger an adaptable transaction determination process, comprising: determining, the active application that initiated the dynamic transaction interface; detecting, a default payment mechanism associated with the active application; and displaying, on the client device, the default payment mechanism on an adaptable transaction interface.

In several aspects the method comprises detecting a runtime environment or app container of the active application; and determining the active application based on the runtime environment or app container.

In various aspects the method further comprises displaying a plurality of payment mechanisms in addition to the default payment mechanism.

In several aspects the dynamic transaction environment of the data object further comprises determining, installation status of a default payment application on the client device; and executing, the default payment application; based on the determining that the default application is installed on the client device.

In various aspects the detecting of the installation status comprises calling a URI handler of the default application.

In several aspects the adaptable transaction determination process further comprises detecting, an operating system of the client device; detecting available payment methods associated with the operating system, in response to detecting no default payment mechanism is associated with the active application; and setting at least one of the available payment methods as the default payment mechanism.

In various aspects the method further comprises completing the transaction, via the default payment mechanism, in response to the transaction request.

In several aspects the completing the payment comprises calling an API of the active application to initiate a payment via the default payment mechanism.

In various aspects the data object comprises a weblink.

In several aspects the transaction request is a request to split a bill or payment.

In various aspects the active application is at least one of a social media application, a browser, or a messaging application.

In several aspects the data object is transmitted as part of a batch request sent to multiple client devices.

In various aspects the present disclosure is generally directed to a method to transmit a batch dynamic transaction request to a plurality of client devices, comprising transmitting, via a server, a plurality of data objects to the plurality of client devices, wherein a data object of the plurality of data objects, upon execution on a client device is configured to: detect, a runtime environment of an active application the data object is executed in; determine, based on the detection of the runtime environment, the active application that the data object is executed in; and detect, a default payment mechanism associated with the active application.

In various aspects the data object upon execution on the client device is further configured to cause a displaying, on the client device, of the default payment mechanism on an adaptable transaction interface.

In many aspects the data object upon execution on the client device is further configured to complete a payment, via the default payment mechanism, in response to the transaction request.

In several aspects the data object upon execution on the client device is further configured to detect, an operating system of the client device; detect available payment methods associated with the operating system; and set the available payment methods as the default payment mechanism.

In various aspects the data object comprises a weblink.

In many aspects the active application is at least one of a social media application, a browser, or a messaging application.

In several aspects the present disclosure is generally directed to a non-transitory computer-readable storage medium having embodied thereon a program, the program being executable by a processor to perform a method comprising determining, an active application where from a data object was executed; and detecting, a default payment mechanism associated with the active application.

In various aspects the non-transitory computer-readable storage medium, wherein the embodied program is executable to perform a method further comprising at least one of the following: detecting, an application container or framework of the active application; completing a payment, via the default payment mechanism; displaying on a client device an adaptable transaction interface to facilitate a payment via the default payment mechanism; detecting, installation status of a default application on the client device; detecting, upon determination that the default application is not installed on the client device, an operating system of the client device; detecting available payment methods associated with the operating system; and calling an API of the active application to initiate a payment via the default payment mechanism.

### BRIEF DESCRIPTION OF THE DRAWINGS

In the description, for purposes of explanation and not limitation, specific details are set forth, such as particular aspects, procedures, techniques, clauses, examples, etc. to provide a thorough understanding of the present technology. However, it will be apparent to one skilled in the art that the present technology may be practiced in other manners that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The methods and systems disclosed herein have been represented where appropriate by conventional symbols in the drawings, showing only those specific details that are pertinent to understanding the aspects of the present disclosure so as not to obscure the disclosure with details that will be readily apparent to those of ordinary skill in the art having the benefit of the description herein.

FIG. 1 illustrates an example user interface of an application capable of providing autonomously adaptable payment transactions, in accordance with at least one aspect of the present disclosure.

FIG. 2 illustrates an example user interface of an application with a virtual card capable of providing autonomously adaptable payment transactions, in accordance with at least one aspect of the present disclosure.

FIG. 3 illustrates an example user interface of an application with a group payment option capable of providing autonomously adaptable payment transactions, in accordance with at least one aspect of the present disclosure.

FIG. 4 illustrates an example user interface of an application capable of providing autonomously adaptable payment transactions and displaying a history of these transactions, in accordance with at least one aspect of the present disclosure.

FIG. 5 illustrates an example user interface of an application capable of providing autonomously adaptable payment transactions showing the status of a request, in accordance with at least one aspect of the present disclosure.

FIG. 6 illustrates an example user interface of an application capable of providing autonomously adaptable payment transactions showing attachments with the request, in accordance with at least one aspect of the present disclosure.

FIG. 7 illustrates a diagram of a number of devices in communication to undertake an adaptable payment transaction request, in accordance was at least one aspect of the present disclosure.

FIG. 8 illustrates a logic flow diagram of a method to provide an autonomously adaptable payment transaction, in accordance with at least one aspect of the present disclosure.

FIG. 9 illustrates a logic flow diagram of a method to create an autonomously adaptable payment transaction request, in accordance with at least one aspect of the present disclosure.

FIG. 10 illustrates a logic flow diagram of a method for an autonomously adaptable payment transaction on a recipient client device.

FIG. 11 illustrates a logic flow diagram of one aspect of a method to undertake an autonomously adaptable payment transaction, in accordance with at least one aspect of the present disclosure.

FIG. 12 presents a block diagram of a computer apparatus, according to at least aspect of the present disclosure.

FIG. 13 is a diagrammatic representation of a system, in accordance with at least one aspect of the present disclosure.

### DETAILED DESCRIPTION

The following disclosure may provide exemplary systems, devices, and methods for autonomously adaptable payment transactions and interfaces and related activities. Although reference may be made to such adaptable payment transactions and interfaces in the examples provided below, aspects are not so limited. That is, the systems, methods, and apparatuses may be utilized for any suitable purpose.

Before discussing specific aspects and examples, some descriptions of terms used herein are provided below.

A “data object” data object may include a link, a web link, an application, a link to an application, a data file such as an image, audio, or video file, executable code, an applet, a script and the like. A data object may also comprise one or multiple files or data objects. A data object may include a data table arrays, pointers, records, files, sets, and scalar types. A data object as used herein may also be written in one or multiple programming languages, including object oriented languages, functional languages, and definitional languages.

A “transaction” may include a payment, or a payment request, receiving a payment, making a payment, a bill, an invoice, a split-bill, or any other transaction involved in the transfer of funds or financial assets from one individual, device, or financial account, to another individual, device or financial account. A “transaction request” for example may include a request to split a bill or split-bill request, a direct request for payment from one or more users or recipients of the request, a sending of an invoice or a bill, or any other request for a transaction involved in the transfer of funds or financial assets from one individual, device, or financial account, to another individual, device or financial account.

An “application” may include any software module configured to perform a specific function or functions when executed by a processor of a computer. For example, a “mobile application” may include a software module that is configured to be operated by a mobile device. Applications may be configured to perform many different functions. A “payment application” may include but is not limited to a software module with similar functionality to a wallet application that has multiple accounts provisioned or enrolled such that they are usable through the wallet application. An “application” may be computer code or other data stored on a computer readable medium (e.g. memory element or secure element) that may be executable by a processor to complete a task.

An application may include a “payment application”, “payment transaction application”, or “wallet application” that may store credentials (e.g., account identifier, expiration date, card verification value (CVV), etc.) for accounts provisioned onto the user device. The account credentials may be stored in general memory on the mobile device or on a secure trusted execution environment (e.g., a secure element) of the user device. Further, in some aspects, the account credentials may be stored by a remote computer and the payment/wallet application may retrieve the credentials (or a portion thereof) from the remote computer before/during a transaction. Any number of different commands or communication protocols may be used to interface with the payment application and/or wallet application in order to obtain and use stored credentials associated with each application.

“User information” may include any information that is associated with a user. For example, the user information may include a device identifier of a device that the user owns or operates and/or account credentials of an account that the user holds.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like).

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer or computing device, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system.

A “user” may include an individual. In some aspects, a user may be associated with one or more personal accounts and/or mobile devices.

In current payment and split-bill transaction systems and platforms, users generally are able to request payments from others and send payment to others via a mobile device or other computing system. However, current technologies face a number of challenges and requirements that hinder the facilitation of transactions between different parties. First, for one party to request a payment from another or send a payment to another, both parties must have an application or specific account installed, for example Venmo, where if one party does not have the application on their device they are requested to install it to use the service. These parties must find each other on this application, as well as link dedicated payment methods such as bank accounts, credit cards, and the like to the application before the application can be used to make or receive payments. The application acts as a user interface between the payment methods that a user must link, and the connected users, connected through the same application. The requirement of having an installed application to facilitate transfer of funds between different parties makes it difficult for users to just undertake a transaction with other parties, without having first to ascertain whether the other party has the application installed or is an account member. This makes things especially difficult between groups, when a person wishing to undertake a transaction with others needs to ascertain who has an application installed, or require them to become members, create an account, or install an application before a transaction could be undertaken.

The solutions presented herein overcome the requirement that both the requester of a transaction or initiator of a transaction request (hereinafter referred to as “requester”) and the recipient of the transaction request (hereinafter referred to as “recipient”) must have an application installed on the device. The current disclosure presents systems and methods utilizing a smart adapter that allows a transaction requester to request to conduct a transaction, for example, a request for payment, or request to send a payment to the recipient, and to any other receiving party (hereinafter may be referred to as “recipient”) regardless of whether the recipient is registered to a payment application, or has a special account or not.

The technologies presented herein allow for communication of a transaction request between the requester and recipient through any available communication medium available on the devices of the requester or recipient, as long as the recipient is able to receive the transaction request or communication. This is because the transaction is packaged in a data object that may be transmitted across networks or via other channels from one device to another. The data object may be a link, wherein the link may be executed to open an application, or to a browser, or other available user interface to the recipient. The systems and methods described herein thus allow for a communication channel-agnostic transmission of transaction requests between a requester and one or more recipient. As long as the recipient has access to a link in one form or another, even through cloud storage mechanisms such as apple notes, google docs, or through social media or other messaging interfaces and applications, then the transaction could be initiated and completed.

Furthermore the current solutions provide a smart adapter that is able to detect, the operating environment of a client device wherefrom the data object is executed, interacted with, or opened in. The operating environment may include any framework, application container, SDK, applet, browser, operating system, or application that the received data object is opened or executed in, opened or executed by, or opened or executed from. The operating or runtime environment may in this disclosure be referred to as an “active application”. The active application may contain default payment mechanisms, these default payment mechanisms are detected by the smart adapter systems and methods herein and provided automatically and autonomously to the user and may be displayed to the user on a customizable and adaptable user interface.

This means that the present disclosure provides for technologies where only one party, the party generating a transaction request, i.e., the requester requires an account (that may be operated in a browser for example) for the creation of that request, or alternatively a payment application installed on their client or mobile device to create the transaction request that is to be sent to the recipient(s). The recipient does not need an account or any specific application or payment application installed on their device. This transaction request is created as a data object with a smart adapter incorporated therein or smart adapter abilities, and transmitted as a data object to any user via any available communication medium including messaging applications, emails, browsers, cloud storage mechanisms, or social media applications. The recipient who receives the transaction request then is able to either interact with the received data object directly or indirectly, triggering a smart adapter mechanism, which detects the user, user details, the active application which may or may not be separate from the communication medium, the operating system, any payment applications, and detect any payment mechanisms associated with the active application (and in some aspects the operating system, or a default payment application) and provide the recipient the default payment mechanism associated with the active application to conduct and complete the transaction, whether it be receiving payment from or sending payment to the requester, depending on the transaction request, and facilitating an uninterrupted transaction.

In various aspects, the present disclosure provides a new, adaptable, and secure transaction system to allow transactions and payment to occur between different parties using one uniform link, capable of being used by multiple recipients, who each receive a customized result based on the runtime environment they utilize on their client devices and associated default payment mechanisms. The uniform link adapts itself to each user environment it is run in, providing each recipient with a quick method to pay based on their own customized environment, without having to input sensitive data or payment information or require the use of applications to conduct transactions.

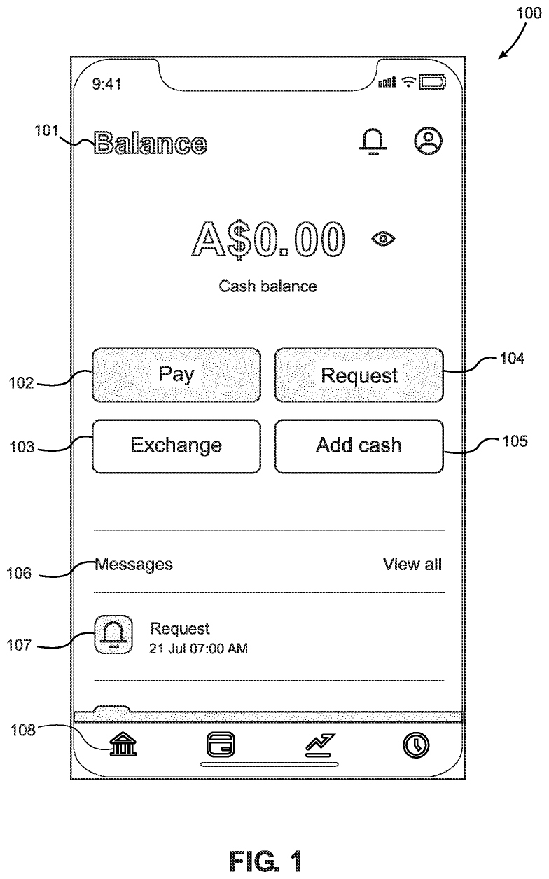

FIG. 1 illustrates an example user interface (may be referred to herein after as “Ul”) of a payment application, or web-based payment account (these collectively hereinafter may be referred to as “payment application” or “payment account”) capable of providing autonomously adaptable payment transactions, in accordance with at least one aspect of the present disclosure. The user interface 100 may be of a main screen of an application, that may include a balance amount 101, a pay button 102 to initiate payments to others, a request button 103 to request payment from others, an exchange button 103 to initiate currency exchanges, or other trading activity that may in some aspects include the trading of stocks, bonds, cyptocurrencies, tokens, or other financial instruments and devices, and an add cash button 105 to allow users of the application to add funds to the payment account and/or cards, wallet, or other payment methods in the application. The UI 100 may also provide recommendations on the best method of payment or requesting payment or funds based on previous activity, or recorded history of a recipient or a requester or any other application or account user. The user interface 100 may include a messages pane 106 that lists the number of requests received and/or sent to and from other individuals, accounts, or devices. There could also be a lower pane 108 that allows the user to navigate between different parts of the application or user interface 100.

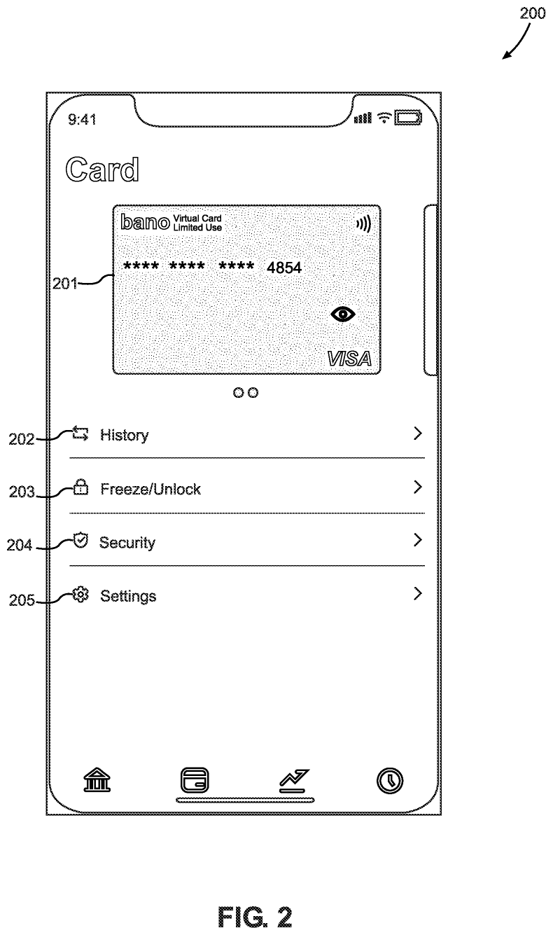

FIG. 2 illustrates an example user interface of an application with a virtual card capable of providing autonomously adaptable payment transactions, in accordance with at least one aspect of the present disclosure. User interface 200 may include one or more virtual cards 201, wallets, bank accounts, fund accounts, trading accounts or other payment methods linked directly to the account on the application of user interface 200. The UI 200 may also include an expandable history section 202, that can display the history of each payment method linked to the account and the requests and completed transactions associated with each payment method. The UI 200 may also include freeze/unlock option, which may lock/freeze and/or unlock cards or payment methods associated with the user account and directly from the application and UI 200. There may be other features on UI 200 including a security button or section 204 and a Setting Screen or Section 205.

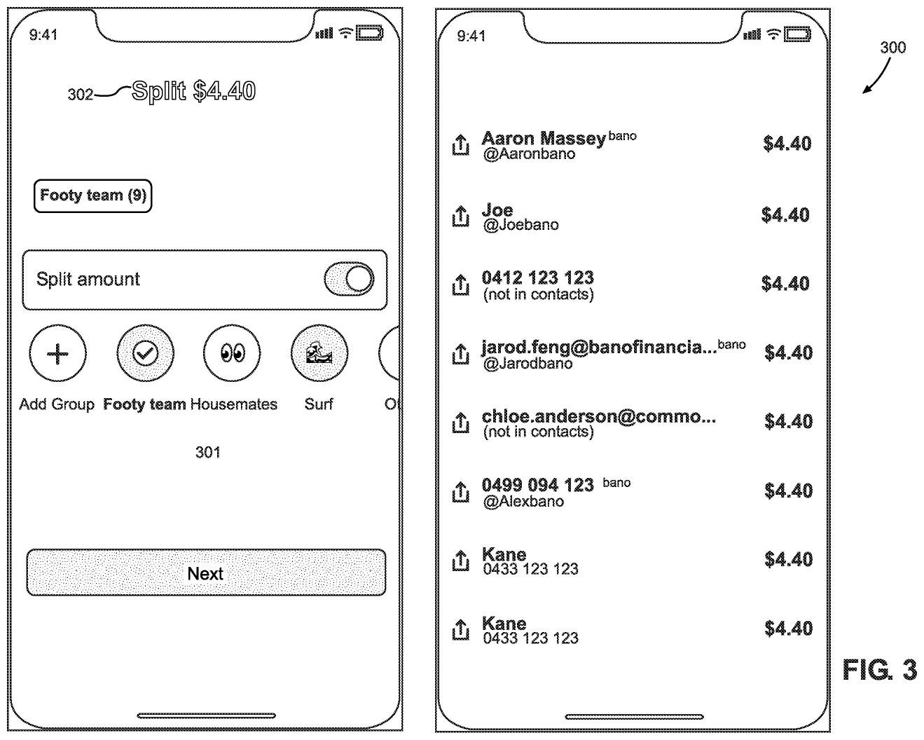

FIG. 3 illustrates an example user interface of an application with a group payment option capable of providing autonomously adaptable payment transactions, in accordance with at least one aspect of the present disclosure. In UI 300, several groups 301 are identified and provided/displayed to a user. The amount to be split 302 as part of the transaction is also provided, while individuals and groups are provided in a separate pane 303. Individuals from separate pane 303 may be selected and added to the selected group with its preset group members for example to be added to the transaction which, for example, may include requesting a payment to split a group bill.

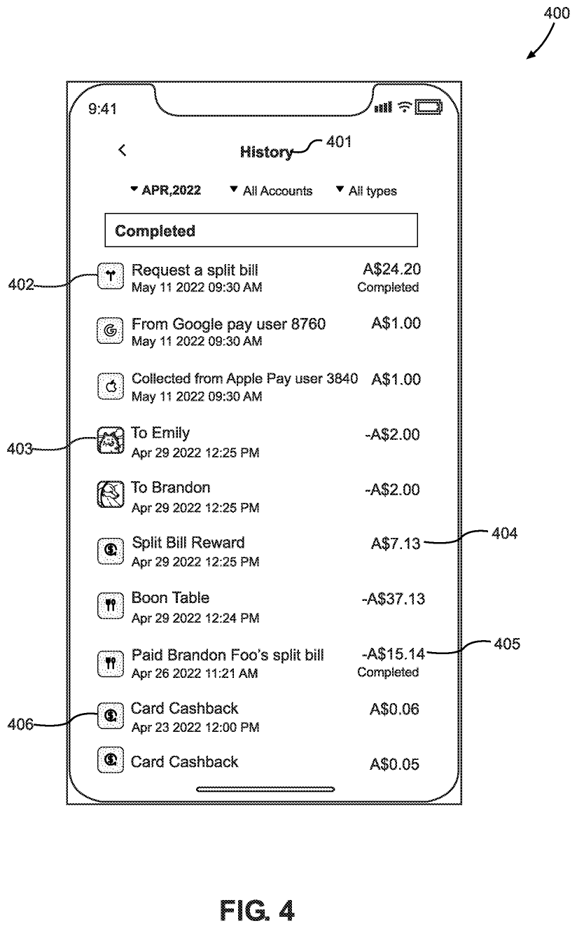

FIG. 4 illustrates an example user interface of an application capable of providing autonomously adaptable payment transactions and displaying a history of these transactions, in accordance with at least one aspect of the present disclosure. The UI 400 includes a history pane 401 or section that shows completed or pending transactions on the payment application running the UI 400. The history pane 401 can include a listing of split-bill transaction requests 402, split-bill transactions payments 403, the amount received 404 from a transaction and amounts paid 405 for a transaction. In various aspects card cashbacks or rewards 406 may also be displayed as they relate with a specific card or transaction. In several aspects, the application not only records previous payment methods for past successful transactions via the application, for example, bank account, card, cash, or other app tokens or currencies but also will prioritize to the user based on the recorded history the best method to request payment from other individuals or recipients.

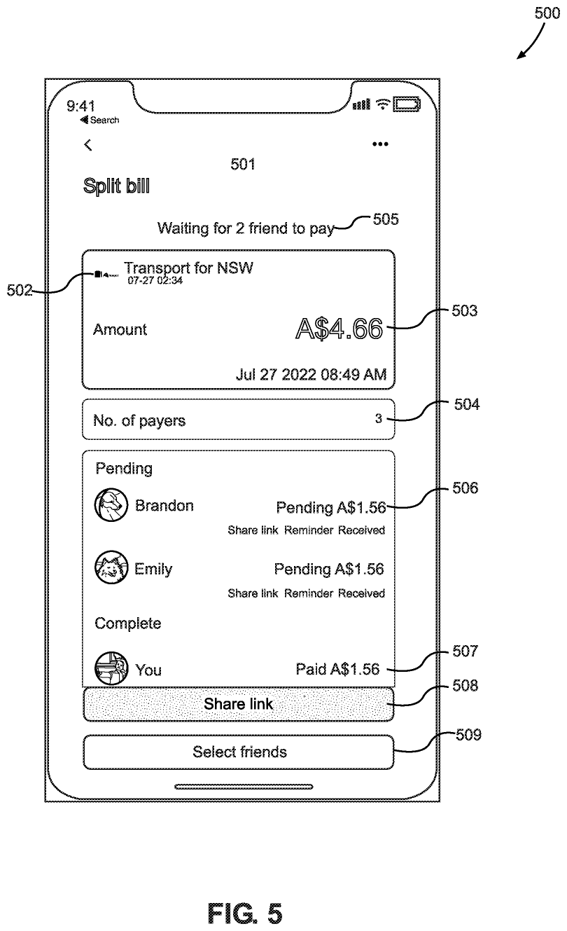

FIG. 5 illustrates an example user interface of an application capable of providing autonomously adaptable payment transactions showing the status of a transaction request, in accordance with at least one aspect of the present disclosure. UI 500 includes a pane 501 of a transaction request that has already been transmitted to other parties. The transaction label 502 or title may be on the pane 501 along with the associated transaction amount 503 may be set out on the pane 501. The total number of recipients 504 that the requester has initiated a transaction with (for example requested a payment from) can be listed along with the number of individuals that have not yet paid 505 out of those of the total number of recipients 504. A section may also be included including individuals that are still pending 506 and have not yet completed the requested transaction. A completed section 507 can also be presented listing recipients that have already completed the transaction. The pane 501 may also include separate buttons, for example a share link 508 button to share the link or transmit the request, or split the bill with additional individuals/recipients. The link may be shared in a variety of different methods with recipients or potential recipients as are discussed in the present disclosure. The pane 501 may also include a ‘select friends’ button 509 that can open a screen for individuals that a user may select from to request a payment from, or split a bill with. Based on the status of payments, those that are complete 507 and those that have not yet paid 506 or completed a transaction, automated reminders may be sent to those recipients that are still pending 506. These automated reminders may be either sent manually by the requester, or automatically set up and sent by the system upon detecting unpaid status 506 of one or more recipients. The system may trigger reminders to recipients that have not yet completed a requested transaction based on the time-lapsed since the initial request was made or time elapsed since a reminder was sent, the transaction amount, amount owed, user settings, or a combination thereof.

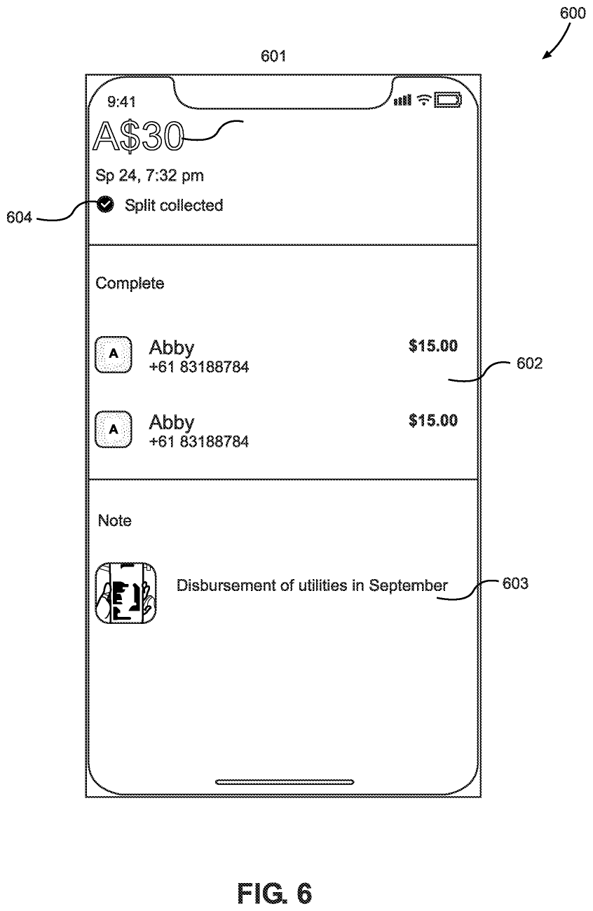

FIG. 6 illustrates an example user interface of an application capable of providing autonomously adaptable payment transactions showing attachments with the request, in accordance with at least one aspect of the present disclosure. The UI 600 may include a transaction amount 601, a completed section 602 or a pending section such as shown in 506, FIG. 5. The UI 600 may also include a notes section 603, which may display a number of items that are related to the transaction, including pictures, videos, audio, messages, or other types of files that were shared within the transaction either by the recipient(s) or the requester. The UI 600 may also include a status portion 604 which indicates whether the transaction has been fully collected, or whether there are outstanding amount(s)/payment(s) that have not been paid.

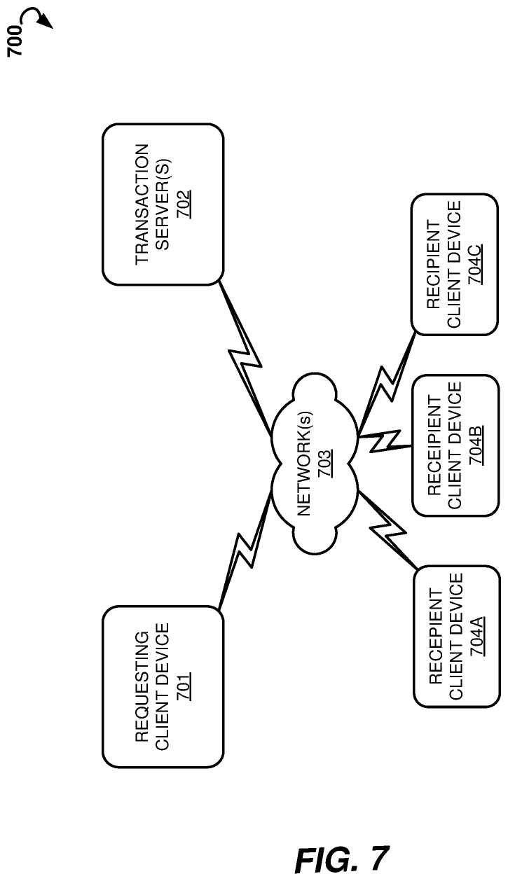

FIG. 7 illustrates a diagram of a number of devices in communication to undertake an adaptable payment transaction request, in accordance was at least one aspect of the present disclosure. The requesting client device 701 initiates a payment or transaction request, for example using the user interfaces 100-600 shown in FIG. 1-6, via an application, browser, or other method. The requesting client device may be connected to a payment transaction server(s) 702 through one or more network(s) 703 or other connection mechanisms. The transaction server(s) 702 may be connected to the same or different network(s) 703 and transmit requests received from requesting client device 701 to one or more of recipient client devices 704A-C. In some aspects, the requesting client device 701 may directly transmit requests to receiving client devices 704A-C via network(s) 703 and associated network architectures or servers bypassing transaction server(s) 702.

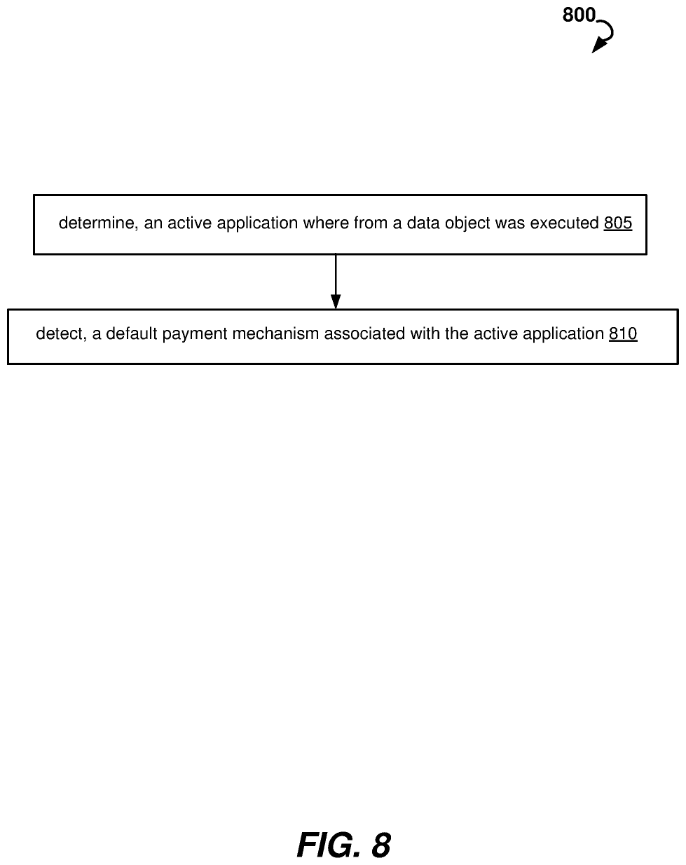

FIG. 8 illustrates a logic flow diagram of a method to provide an autonomously adaptable payment transaction, in accordance with at least one aspect of the present disclosure. A data object on a user, client, mobile, computing or other device may execute a data object that is received, the data object may be a payment transaction request, which may as a non-limiting example include a request to split a bill. The data object may be executed or opened on an application, a web browser, or via other means. The method 800 includes determining 805 the application, (referred to herein as the “active application”), that opened or executed the data object or request that was received (or wherefrom or wherein the data object was opened, selected or executed). Based on the detected application that executed the data object, a default payment mechanism associated with the active application is identified or detected 810. For example, if the application that executed the data object, or wherefrom a user selected or clicked the data object is the messenger application “iMessage” then “Apple Pay” may be detected as the default payment mechanism, while if the data object is executed in “Whatsapp” Messenger, then “Whatsapp Payment” may be detected as the default payment mechanism. If the data object is executed in “Facebook Messenger” or other social media application, then the default payment method of that application or social media platform is determined, for example “Meta pay” or “Facebook Pay”. These steps may be undertaken by the data object, script, or software code in the data object, and in various aspects in conjunction with the underlying operating system, installed applications and requesting client devices, such as recipient client devices 704A-C, FIG. 7 that received and executed the data object.

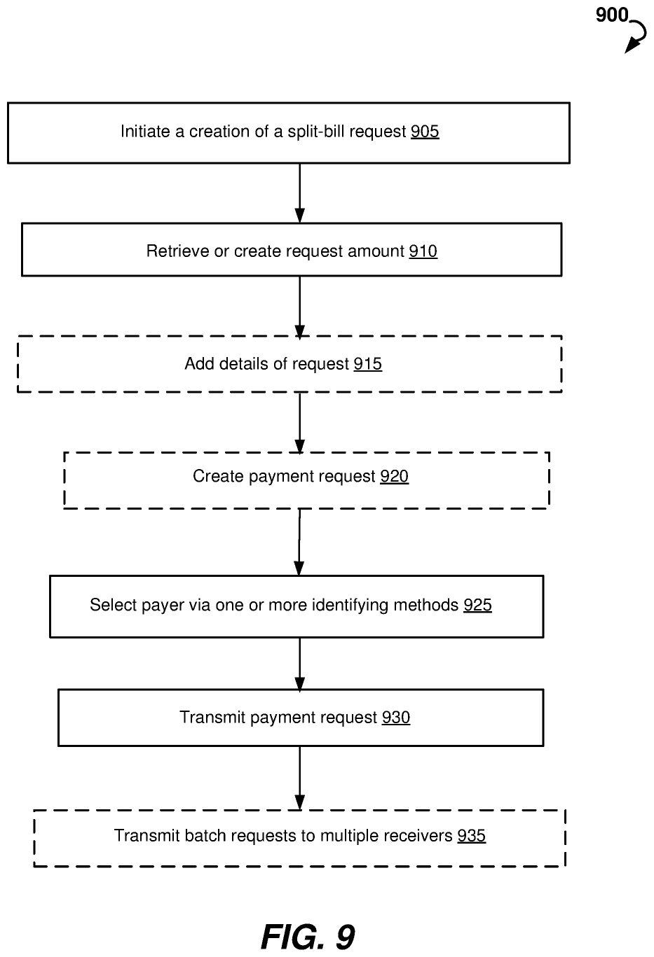

FIG. 9 illustrates a logic flow diagram of a method to create an autonomously adaptable payment transaction request, in accordance with at least one aspect of the present disclosure. Method 900 may be undertaken generally by a requesting client device, such as requesting client device 701, FIG. 7, generally via a dedicated payment application on the client device, or alternatively payment account that may be accessed or used via a browser. Method 900 includes initiating 905 a creation of a split-bill request, or alternatively a payment request. The user may create or retrieve 910 a request amount. Retrieving a request amount may include a user selecting a transaction, transaction details, or history of a transaction card that is associated with a payment application or account.

In some aspects a transaction may be accessed or selected on the payment account from a digital receipt, a pending, or a completed transaction, transaction details, or even from a regular receipt that is digitized, wherein an image of a receipt may be converted into a digital receipt. In various aspects, the pending or completed transaction details are automatically detected from saved or associated transactions, digital or digitized receipts, or other associated and detected payments, that may be from associated or already linked payment methods from the requester device, or default payment application or payment account. The transaction details are then retrieved from the application and presented on a user interface to the user in the initiating 905 step. The requester may then add details 915 to the payment request, details may include and are not limited to messages, text or otherwise, notes, audio recordings or files, video recordings or files, images, annotations, and Emoji. In several aspects, optionally, a data object representing or comprising the transaction request or payment request, may be created 920 by the payment account, user, automatically, and in some aspects manually, after or before any one or more steps 905-925.

The user then selects 925 one or more recipients or recipient payers via one or more methods. In various aspects, a recipient may be selected from a contact book, user or friend list associated with the user account or device, or can add recipients manually into the device using their phone number, email, or social media accounts. In various aspects of the disclosure, the payment account or application is able to detect all applications with contact lists installed on the user or client device or otherwise connected to the payment account. The payment account or application is then able to retrieve a list of all names and contact details of users connected to the requester, when the requester then selects a recipient they may be selected from any of the contact details that are available. For example, a requester user selects a transaction to create 910 a request amount and then is provided a list of potential recipients, these recipients may be retrieved from the requester user's email contact list, his phone book on the client device, as well as connected accounts and users (such as online friends, followers, or subscribers) on the various social media accounts the user is connected to, has installed, or the user's account is associated with.

The requester may select 925 any one of these connected or associated payment accounts or individuals to send or transmit 930 the transaction or payment request to, via the specific communication channel or medium that recipient is connected to the requester through, so for example, when a user from a Facebook connection is selected, a transaction request would be sent to that user through Facebook Messenger, and when a user is selected based on their phonebook contacts, the default communication or messaging application the phonebook contacts utilizes is used to transmit the request to, for example iMessage. An individual or contact may be listed or connected through various different communication methods. For example the requester may be connected to the recipient through one or more social media accounts as well as their email address, and any one of these connections may be used to transmit a transaction or payment request from the requester to transaction recipient.

Optionally, multiple users may be selected by the requester to transmit a batch request 935 to multiple request recipients. In various aspects, the requester may select how much each user should pay, while in other aspects of the disclosure, the bill or transaction is split evenly or in preset amounts for each user. In several aspects of the invention the payment request must first be created 920 before it is transmitted 930. While in other aspects, the data object comprising the request is created 920 as each recipient is selected 925. In various aspects the created data object may be embedded in a communication interface or medium, such as an email message yet to be sent, a message to be sent on a messaging app, social media application, or browser link, as a recipient and the communication medium is selected 925. As discussed herein the data object may include and is not limited to a link, a file, a web link or a combination as defined in this disclosure. In several aspects, the same link is created for each recipient, the link or data object being interchangeable between recipients, and communication mediums. In several aspects the recipients selected 925 may be actually groups selected from the interface, the groups may be created in the dedicated payment application, or be created, or have been previously created in a social media application, or any other application associated with the requester, the requester's accounts, including any social media accounts or other accounts associated with the requester and/or the requesting client device 701, FIG. 7.

In several aspects the payment application or payment account is able to pull the requester and requester's data from the client device 701, including the various contacts associated with requester on the various social media, messaging, email, or other communication or any other application that utilize contacts and connections, to compile the various recipient selection options that are displayed and available to the requester on the payment application or payment account. As a non-limiting example, a selection may comprise a group that is separately created on Meta-Facebook, which is automatically detected and imported by the payment application or payment account. In several aspects, groups created on other banking or payment applications may also be accessed by the payment account, wherein the groups may allow the creation of an individual link that is transmitted to the whole group via one or more communication channels. The members of the group may each open the same link and receive a payment request that is adaptive to each of them personally and the amounts they each owe. As each recipient completes a payment, this may be reported to the requester via the payment account. In several aspects, the social media group that is detected by the payment account is provided a link via the dedicated or default messaging application of that social media platform, or posted directly to the page of that group on the social media platform, wherein the link or data object may be accessed by each member of the group individually via their respective devices.

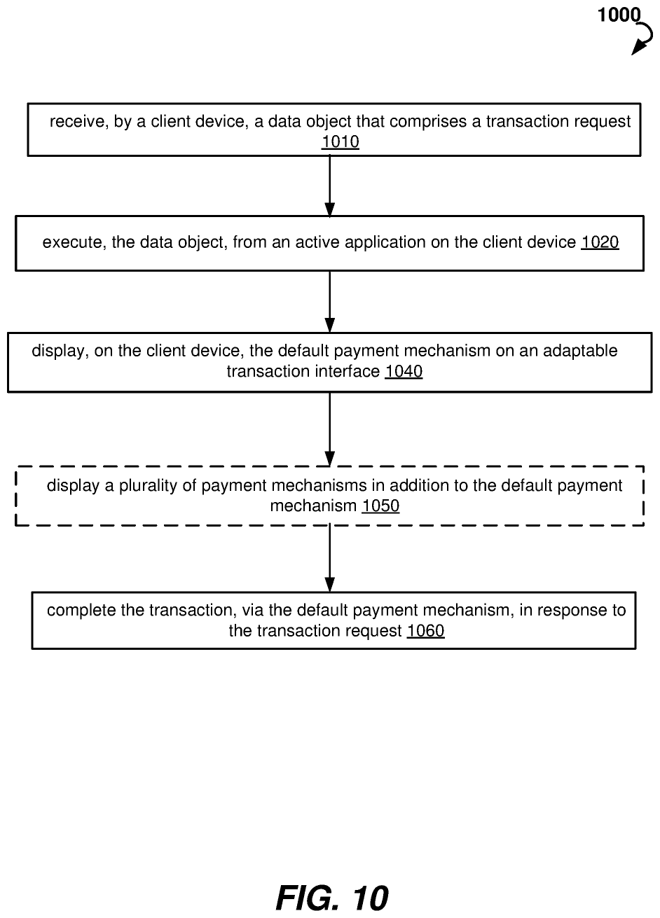

FIG. 10 illustrates a logic flow diagram of a method for an autonomously adaptable payment transaction on a recipient client device, in accordance with at least one aspect of the present disclosure. The method 1000 presents one aspect that may include receiving 1010 by a recipient client device, for example client device 704A-C, FIG. 7, a data object that comprises a transaction request. The data object may be a link or a web link that is received on the client device 704A-C through an application, a browser, or other communication channel or medium such as email, message or texting applications, social media applications and the like. The users of client device 704A-C, may open, click, or otherwise execute 1020 the data object, from an active application on the client device 704A-C. In several aspects the executing comprises clicking a link, selecting a button, or otherwise executing a script or applet. The data object is opened in the application, browser or communication medium it was received in, in various other aspects of the disclosure, while the link is received in one communication medium, it may be copied into another medium and opened there. For example a link is received in a social media application, it is copied by the receiving user and opened in a messaging application.

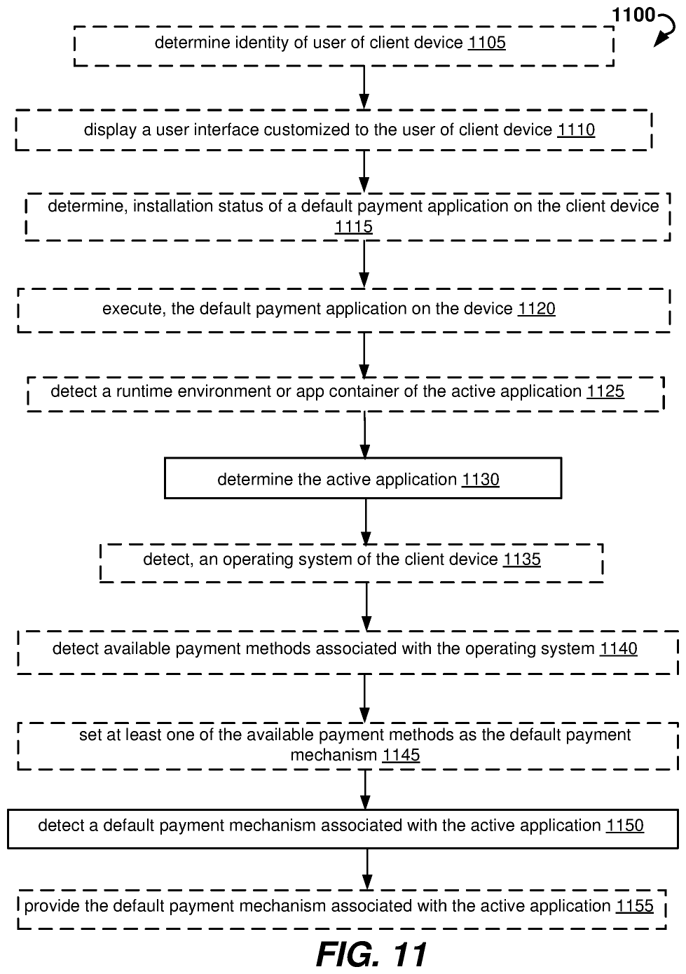

In several aspects, once the user clicks, opens, or otherwise executes 1020 the data object, the execution of which triggers on the client device, an adaptable transaction determination process. This adaptable transaction determination process is explained in further details in FIG. 8 and FIG. 11. The adaptable transaction determination process may comprise and is not limited to steps 805 and 810 in FIG. 8 and/or any one or more combinations of steps from FIG. 11. A purpose of the adaptable transaction determination process (may also be referred to hereinafter as “determination process”) is to determine a default payment mechanism for the environment that the data object is executed from.

The determined default payment mechanism may be displayed 1040 on the client device 704A-C, in some aspects an adaptable user interface that is displayed either on the web browser that the received data object (link) opened to, the active application that received the link, a default installed payment application, or a separate user interface that provides the default payment mechanism(s), for example overlaying the messaging or active application. In various optional aspects, the adaptable user interface may display multiple 1050 payment mechanisms in addition to the default payment mechanism. For example, the adaptable user interface may include a primary default payment mechanism linked to a social media application, but also include a payment mechanism that is associated with the operating system, as well as a payment mechanism associated or saved by the browser, and these various payment mechanisms may then be displayed in a specific order, based on the runtime environment or based on usage data retrieved from the user device or connected applications and accounts. Finally the transaction may be conducted and completed 1060, via the default payment mechanism, in response to the transaction request. The completing of the transaction may include sending or receiving a payment of funds or other financial instruments in response to the transaction request in the data object. The transaction request may be completed via a payment mechanism linked to the client device 701, or the active application, or a default application that is detected, but is completed generally via one or more determined default payment mechanisms.

FIG. 11 illustrates a logic flow diagram of one aspect of a method to undertake an autonomous adaptable transaction determination process on a receiving client device 704A-C, FIG. 7, in accordance with at least one aspect of the present disclosure. The method 1100, i.e., the autonomous adaptable payment transaction determination process, may be triggered in step 1020, FIG. 10 for example after a data object is received 1010, FIG. 10 via an active application. Once the determination process is triggered, for example by opening, clicking, or executing 1020 a link, an applet, script, or executable object, the determination process may optionally begin by determining the identity 1105 of the recipient, or retrieve user data that is accessible to it in the recipient client device(s) 704A-C, FIG. 7. The data object that is executed 1020 may include a script that is triggered to begin the determining process, the script that is run may interact with the operating system of the client device 704A-C to retrieve all user data linked or accessible to the script as provided by client device 704A-C and use this data to determine 1105 the user that is interacting with the transaction request, this is especially relevant when a link is sent to multiple users, or a group comprised of many users. In various aspects, the data object presents or displays 1110 a user interface on any of: an installed dedicated payment application, the active application that opened the data object, or the browser, wherein the Ul is customizable or personalized to the recipient of the client device. This customization may include displaying the amount that is requested to be paid by or to the user of the client device 704A-C. In various aspects, the displaying 1110 occurs at, as part of, within, or alongside step 1050, FIG. 10. In several aspects a user interface displayed 1110 is a web browser that is opened from a data object that may comprise a web link.

Optionally, and in several aspects the determining process may include determining 1115 an installation status of a default payment application on the client device, this could for example be the same application that created and/or transmitted the data object, i.e., the application used by the requester on the requester client device 701, FIG. 7. The detecting 1115 may include the executed data object automatically running a script, that may be written in JavaScript or any other suitable language, that may call the URI handler of a default payment application. If the script is successful in calling the URI handler, then the default payment application can be executed 1120, or activated on the client device, and pulled up to provide a payment, or transaction interface to respond to the request associated or linked to the default payment application. Examples of default user interfaces of a default payment application that is executed 1120 may include those in FIG. 1-6. The installed default payment application may then provide default payment options associated with the payment application, and provide other options such as payment conversions, currency conversions and the like.

Optionally, and in several aspects the determining process may include detecting 1125 a runtime environment, application, or application container of the active application that the data object was executed in, executed by, or executed from. The detecting 1125 may include automatically running a script, that may be written in JavaScript or any other suitable language, which may call one or more URI handlers to detect the runtime environment, the browser, or the container of the active application. Otherwise the detecting 1125 may include using identifiers associated with the active application and its components. Once the detecting 1125 of an active application, its container or runtime environment is undertaken, the method 1100 includes determining 1130 the active application. In several aspects, the active application may be a browser or browser environment, an application, a social media application, a messaging application, or software which includes a communication mechanism. In most aspects, the method then attempts to determine 1150 whether a wallet, or default payment mechanism is associated with the active application, and may optionally provide 1155 the default payment mechanism to client device 704A-C via a display 1050, FIG. 10, or display 1110 this payment mechanism to the user of the client device 704A-C.

A non-limiting example of this determining 1130 may commence after a user receives a link via Meta-Facebook Messenger, and clicks the link from the interface of Meta-Facebook Messenger, in this instance, the Meta-Facebook Messenger is the active application that the data object or link is executed in, executed by, or executed from. Once a data object is executed 1020 and the determination process is triggered, and determining 1130 is carried out, then the default payment mechanism is detected 1150 and optionally may be provided 1155 to the user of client device 704A-C as part of displaying 1050, FIG. 10 or displaying 1110. For example, Facebook Pay may be provided 1155 to the user as a default payment mechanism, when the data object is executed in Facebook Messenger.

In several aspects, optionally, the method 1100 may include detecting 1135 the operating system of client device 704A-C. This could occur in several scenarios including and not limited to if there is no default payment mechanism associated with the active application, no payment method was detected, or no active application was determined 1130 then the method 1100 would optionally include determining available payment methods associated with the operating system 1140. These payment methods may include wallets, linked cards, banking applications, and other payment methods accessible via the operating system. In several optional aspects, this payment mechanism is set 1145 as the default payment mechanism that is provided 1160 or displayed 1050, FIG. 10 or 1110 to the user on client device 704A-C.

In various aspects, multiple payment mechanisms may be identified that are associated with an application, browser, operating system and the like and displayed 1050, 1110 and/or provided 1160 to a user of receiving client device 704A-C. A transaction may be conducted, and completed via the provided default payment mechanism or one or more multiple default payment mechanisms on receiving client devices 704A-C. In some aspects all the determining steps may be combined, or determining of default payment mechanisms of several applications or operating environments may all be displayed 1050, 1110, or provided 1160 to the user. For example, the method 1100 may include determining a default payment mechanism of the operating system which may be a specific credit card linked to a wallet, as well as a payment mechanism associated with, or saved by a browser the user opened by default when clicking on the link or data object, for example “PayPal”, as well as the payment mechanism associated with the active application, for example the messaging or social media application that opened the application, Facebook Messenger, and therefore the UI would provide “Facebook Pay” In this instance, all these different payment mechanisms may be provided. In addition, in some aspects the active application may comprise more than one application, which may include the messaging application, or communication medium the data object was executed or opened from, and the browser the data object opened by default, and therefore the default payment mechanism of both of these applications or environments is determined by the steps described herein and then provided 1160, or displayed 1050, 1110 to the recipient. In most aspects the active application refers to the application the data object was executed or opened by, executed or opened from, or executed or opened in, and the browser is a mere user interface providing an adaptable interface for each recipient.

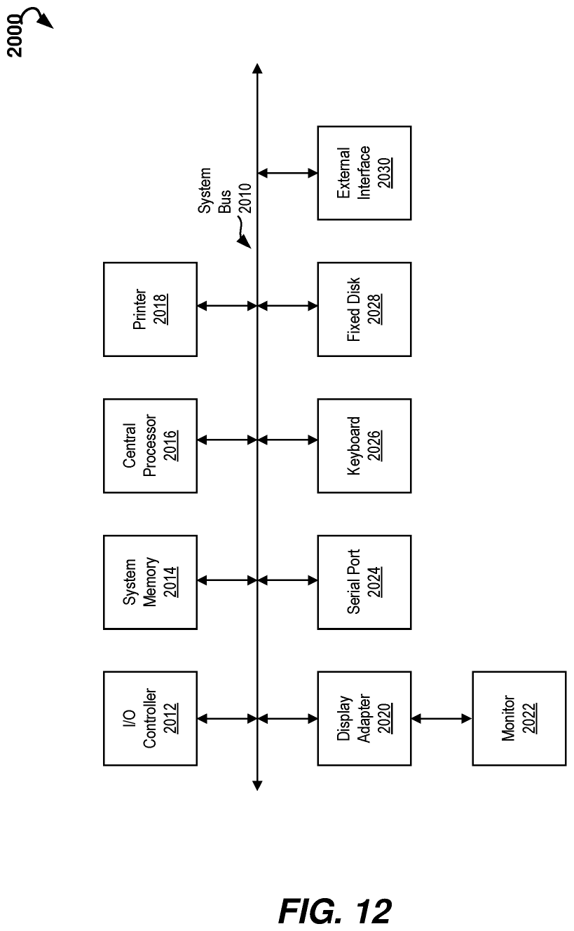

FIG. 12 presents a block diagram of a computer apparatus, according to at least aspect of the present disclosure. The presented example computer apparatus or subsystems may be used to perform the methods and functions described herein. The example computer apparatus 2000 also referred to herein as subsystems 2000 are interconnected via a system bus 2010. Additional subsystems such as a printer 2018, keyboard 2026, fixed disk 2028 (or other memory comprising computer readable media), monitor 2022, which is coupled to display adapter 2020, and others are shown. Peripherals and input/output (I/O) devices, which couple to I/O controller 2012 (which can be a processor or other suitable controller), can be connected to the computer system by any number of means known in the art, such as serial port 2024. For example, serial port 2024 or external interface 2030 can be used to connect the computer apparatus to a wide area network such as the Internet, a mouse input device, or a scanner. The interconnection via system bus 2010 allows the central processor 2016 to communicate with each subsystem and to control the execution of instructions from system memory 2014 or the fixed disk 2028, as well as the exchange of information between subsystems. The system memory 2014 and/or the fixed disk 2028 may embody a computer readable medium.

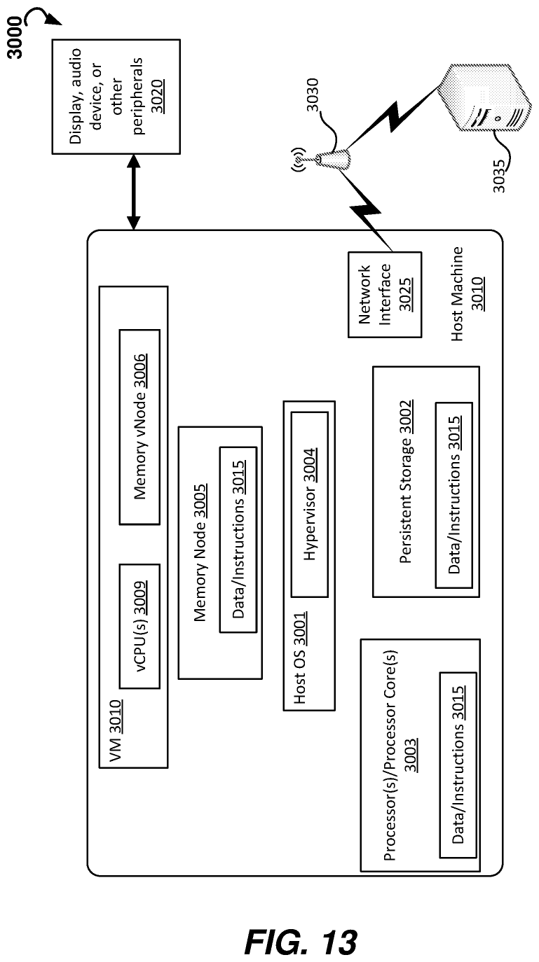

FIG. 13 is a diagrammatic representation of a system 3000, in accordance with at least one aspect of the present disclosure. The system 3000 includes a host machine 3010, within which a set of instructions for causing the host machine 3010 to perform any one or more of the methods, or portions of the methods, described by the present disclosure may be executed. In various example aspects, the host machine 3010 operates as a standalone device or may be connected (e.g., networked) to other machines. In a networked deployment, the host machine 3010 may operate in the capacity of a server or a client machine in a server-client network environment, or as a peer machine in a peer-to-peer (or distributed) network environment. The host machine 3010 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 3000 includes the host machine 3010, running a host operating system (OS) 2001 on a processor or multiple processor(s)/processor core(s) 3003 (e.g., a central processing unit (CPU), a graphics processing unit (GPU), or both), and various memory nodes 3005. Host OS 3001 may include a hypervisor 3004 which is able to control the functions and/or communicate with a virtual machine (“VM”) 3010 running on machine readable media. VM 3010 may also include a virtual CPU or vCPU 3009. Memory nodes 3005, and 3007 may be linked or pinned to virtual memory nodes or vNodes 3006 respectively. When a memory node 3005 is linked or pinned to a corresponding virtual node 3006, then data may be mapped directly from the memory nodes 3005 to their corresponding vNodes 3006.

All the various components shown in host machine 3010 may be connected with and to each other, or communicate to each other via a bus (not shown) or via other coupling or communication channels or mechanisms. The host machine 3010 may further include a video display, audio device or other peripherals 3020 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 3002 (also referred to as disk drive unit), and a network interface device 3025. The host machine 3010 may further include a data encryption module (not shown) to encrypt data.

The components provided in the host machine 3010 are those typically found in computer systems that may be suitable for use with aspects of the present disclosure and are intended to represent a broad category of such computer components that are known in the art. Thus, the system 3000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 3002 may also be a Solid-state Drive (SSD), a hard disk drive (HDD) or other includes a computer or machine-readable medium on which is stored one or more sets of instructions and data structures (e.g., data or instructions 3015) embodying or utilizing any one or more of the methodologies or functions described herein. The instructions 3015 may also reside, completely or at least partially, within the main memory node 3005 and/or within the processor(s) 3003 during execution thereof by the host machine 3010. The processor(s) 3003, and memory nodes 3005 may also comprise machine-readable media.

The instructions 3015 may further be transmitted or received over a network 3030 via the network interface device 3025 utilizing any one of several well-known transfer protocols (e.g., Hyper Text Transfer Protocol (HTTP)). The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the machine 3010 and that causes the machine 3010 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the aspects of the disclosure as described herein.

The computer program instructions may also be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 2030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 3010, with each server 3035 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. An automated computer implemented method to provide dynamic, adaptable and secure payment transaction interfaces based on a runtime environment, the method comprising receiving, by a client device, a data object that comprises a transaction request; executing, the data object, from an active application on the client device to trigger an adaptable transaction determination process, comprising determining, the active application that triggered the adaptable transaction determination process; detecting, a default payment mechanism associated with the active application; and displaying, on the client device, the default payment mechanism on an adaptable transaction interface.

Clause 2. The method of Clause 1, wherein the determining the active application comprises detecting a runtime environment or app container of the active application; and determining the active application based on the runtime environment or app container.

Clause 3. The method of any one of Clauses 1-2, wherein the method further comprises displaying a plurality of payment mechanisms in addition to the default payment mechanism.

Clause 4. The method of any one of Clauses 1-3, wherein the adaptable transaction determination process further comprises determining, installation status of a default payment application on the client device; and executing, the default payment application; based on the determining that the default application is installed on the client device.

Clause 5. The method of any one of Clauses 1-4, wherein the detecting of the installation status comprises calling a URI handler of the default application.

Clause 6. The method of any one of Clauses 1-5, wherein the adaptable transaction determination process further comprises detecting, an operating system of the client device; detecting available payment methods associated with the operating system, in response to detecting no default payment mechanism is associated with the active application; and setting at least one of the available payment methods as the default payment mechanism.

Clause 7. The method of any one of Clauses 1-6, wherein the method further comprises completing the transaction, via the default payment mechanism, in response to the transaction request.

Clause 8. The method of any one of Clauses 1-7, wherein the completing the payment comprises calling an API of the active application to initiate a payment via the default payment mechanism.

Clause 9. The method of any one of Clauses 1-8, wherein the data object comprises a weblink.

Clause 10. The method of any one of Clauses 1-9, wherein the transaction request is a request to split a bill or payment.

Clause 11. The method of any one of Clauses 1-10, wherein the active application is at least one of a social media application, a browser, or a messaging application.

Clause 12. The method of any one of Clauses 1-11, wherein the data object is transmitted as part of a batch request sent to multiple client devices.

Clause 13. A method to transmit a batch dynamic transaction request to a plurality of client devices, comprising transmitting, via a server, a plurality of data objects to the plurality of client devices, wherein a data object of the plurality of data objects, upon execution on a client device is configured to: detect, a runtime environment of an active application the data object is executed in; determine, based on the detection of the runtime environment, the active application that the data object is executed in; and detect, a default payment mechanism associated with the active application.

Clause 14. The method of Clause 13, where the data object upon execution on the client device is further configured to cause a displaying, on the client device, of the default payment mechanism on an adaptable transaction interface.

Clause 15. The method of Clauses 13-14, where the data object upon execution on the client device is further configured to: complete a payment, via the default payment mechanism, in response to the transaction request.

Clause 16. The method of Clauses 13-15, where the data object upon execution on the client device is further configured to detect, an operating system of the client device; detect available payment methods associated with the operating system; and set the available payment methods as the default payment mechanism.

Clause 17. The method of Clauses 13-16, wherein the data object comprises a weblink.

Clause 18. The method of Clauses 13-17, wherein the active application is at least one of a social media application, a browser, or a messaging application.

Clause 19. A non-transitory computer-readable storage medium having embodied thereon a program, the program being executable by a processor to perform a method comprising determining, an active application where from a data object was executed; and detecting, a default payment mechanism associated with the active application.

Clause 20. The non-transitory computer-readable storage medium of Clause 19, wherein the embodied program is executable to perform a method further comprising at least one of the following: detecting, an application container or framework of the active application; completing a payment, via the default payment mechanism; displaying on a client device an adaptable transaction interface to facilitate a payment via the default payment mechanism; detecting, installation status of a default application on the client device; detecting, upon determination that the default application is not installed on the client device, an operating system of the client device; detecting available payment methods associated with the operating system; and calling an API of the active application to initiate a payment via the default payment mechanism.

The foregoing detailed description includes references to the accompanying drawings, which form a part of the detailed description. The drawings show illustrations in accordance with exemplary aspects. These example aspects, which are also referred to herein as “examples,” are described in enough detail to enable those skilled in the art to practice the present subject matter.

The various aspects described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred aspect should not be limited by any of the above-described exemplary aspects.

While specific aspects of, and examples for, the system are described above for illustrative purposes, various equivalent modifications are possible within the scope of the system, as those skilled in the relevant art will recognize. For example, while processes or steps are presented in a given order, alternative aspects may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The aspects can be combined, other aspects can be utilized, or structural, logical, and electrical changes can be made without departing from the scope of what is claimed. It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. The detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more”to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.).

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,”, “an embodiment”, “one embodiment”, “an exemplification,” “one exemplification,”, and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary aspects were chosen and described to best explain the principles of the present technology and its practical application, and to enable others of ordinary skill in the art to understand the invention for various aspects with various modifications as are suited to the particular use contemplated.

It is to be understood that, if any prior art publication is referred to herein, such reference does not constitute an admission that the publication forms a part of the common general knowledge in the art, in Australia or any other country.

1. An automated computer implemented method to provide dynamic, adaptable and secure payment transaction interfaces based on a runtime environment, the method comprising:
receiving, by a client device, a data object that comprises a transaction request;
executing, the data object, from an active application on the client device to trigger an adaptable transaction determination process, comprising:
determining, the active application that triggered the adaptable transaction determination process;
detecting, a default payment mechanism associated with the active application; and
displaying, on the client device, the default payment mechanism on an adaptable transaction interface.

2. The method of claim 1, wherein the determining the active application comprises:
detecting a runtime environment or app container of the active application; and
determining the active application based on the runtime environment or app container.

3. The method of claim wherein the method further comprises:
displaying a plurality of payment mechanisms in addition to the default payment mechanism.

4. The method of claim 1, wherein the adaptable transaction determination process further comprises:
determining, installation status of a default payment application on the client device; and
executing, the default payment application; based on the determining that the default application is installed on the client device.

5. The method of claim 4, wherein the determining of the installation status comprises calling a URI handler of the default application.

6. The method of claim 1, wherein the adaptable transaction determination process further comprises:
detecting, an operating system of the client device;
detecting available payment methods associated with the operating system, in response to detecting no default payment mechanism is associated with the active application; and
setting at least one of the available payment methods as the default payment mechanism.

7. The method of claim 1, wherein the method further comprises:
completing the transaction, via the default payment mechanism, in response to the transaction request.

8. The method of claim 7, wherein the completing the payment comprises:
calling an API of the active application to initiate a payment via the default payment mechanism.

9. The method of claim 1, wherein the data object comprises a weblink.

10. The method of claim 1, wherein the transaction request is a request to split a bill or payment.

11. The method of claim 1, wherein the active application is at least one of a social media application, a browser, or a messaging application.

12. The method of claim 1, wherein the data object is transmitted as part of a batch request sent to multiple client devices.

13. A method to transmit a batch dynamic transaction request to a plurality of client devices, comprising:
transmitting, via a server, a plurality of data objects to the plurality of client devices, wherein a data object of the plurality of data objects, upon execution on a client device is configured to:
detect, a runtime environment of an active application the data object is executed in;
determine, based on the detection of the runtime environment, the active application that the data object is executed in; and
detect, a default payment mechanism associated with the active application.

14. The method of claim 13, where the data object upon execution on the client device is further configured to:
cause a displaying, on the client device, of the default payment mechanism on an adaptable transaction interface.

15. The method of claim 15, where the data object upon execution on the client device is further configured to:
complete a payment, via the default payment mechanism, in response to the batch dynamic transaction request.

16. The method of claim 13, where the data object upon execution on the client device is further configured to:
detect, an operating system of the client device;
detect available payment methods associated with the operating system; and
set the available payment methods as the default payment mechanism.

17. The method of claim 13, wherein the data object comprises a weblink.

18. The method of claim 13, wherein the active application is at least one of a social media application, a browser, and a messaging application.

19. A non-transitory computer-readable storage medium having embodied thereon a program, the program being executable by a processor to perform a method comprising:
determining, an active application wherefrom a data object was executed; and
detecting, a default payment mechanism associated with the active application.

20. The non-transitory computer-readable storage medium of claim 19, wherein the embodied program is executable to perform a method further comprising at least one of the following:
detecting, an application container or framework of the active application;
completing a payment, via the default payment mechanism;
displaying on a client device an adaptable transaction interface to facilitate a payment via the default payment mechanism;
detecting an installation status of a default application on the client device;
detecting, upon determination that the default application is not installed on the client device, an operating system of the client device;
detecting available payment methods associated with the operating system; and
calling an API of the active application to initiate a payment via the default payment mechanism.
